(19) United States
(12) Patent Application Publication
(10) Pub. No.: US 2024/0375572 A1
(43) Pub. Date: Nov. 14, 2024

(54) AUTONOMOUS CROP HARVEST AND STORAGE SYSTEM

(71) Applicant: Silonz LLC, Brook, IN (US)

(72) Inventor: Kyler Laird, Rensselaer, IN (US)

(73) Assignee: Silonz LLC, Brook, IN (US)

(21) Appl. No.: 18/780,690

(22) Filed: Jul. 23, 2024

Related U.S. Application Data
(63) Continuation of application No. PCT/US2023/061082, filed on Jan. 23, 2023.
(60) Provisional application No. 63/297,153, filed on Jan. 6, 2022.

(51) Int. Cl. B60P 3/06; A01D 90/12; A01D 90/16; B60P 7/04

(52) U.S. Cl. CPC B60P 3/066; A01D 90/12; A01D 90/16; B60P 7/04

(57) ABSTRACT

A crop harvesting system for reducing crop unloading times. The system includes a real-time job market for crop load delivery. The system further includes a depot for crop drop off. In one example, a farmer transfers harvested crops into a trailer, a driver is notified via an app of a load meeting a predefined criteria, the trailer is transported to the depot and dropped off by the driver, a dump mule picks up the trailer, and the dump mule transfers the trailer to a storage container where the crop is stored.

### REFERENCE TO RELATED APPLICATIONS

This application is a continuation of International Patent Application Number PCT/US2023/061082, filed Jan. 23, 2023, which is hereby incorporated by reference. International Patent Application Number PCT/US2023/061082, filed Jan. 23, 2023, claims the benefit of U.S. Patent Application No. 63/267,153, filed Jan. 26, 2022, which are hereby incorporated by reference.

### BACKGROUND

Crop receiving facilities, for example grain elevators, are expensive and geographically sparse. During the crop harvesting season farmers experience long crop transit times and long wait times for crop unloading. These long wait times reduce overall harvest efficiency.

Thus, there is a need for improvement in this field.

### SUMMARY

A unique real-time marketplace for crop transfer has been developed. The marketplace includes a remote device supporting a real-time marketplace and job board. The real-time marketplace displays crop data such as crop type, crop load weight, moisture content, and location information. The real-time job board includes information such as a real-time Global Positioning System (GPS) location of the crop load, load destination, and payment amount for transport.

In one example, the job board matches available drivers with available loads via a bidding system. In another example, the job board matches available drivers with available loads via a flat rate payment system. In yet another example, the job board matches available drivers with available loads via a proximity measurement. The proximity measurement sends a pickup/drop off request to the available driver nearest the available load. If the driver refuses, the system sends a request to the next closest available driver.

The marketplace functions in combination with an autonomous vehicle and trailer configured to collect harvested crops from a combine. The trailer includes one or more load sensors, one or more moisture sensors, and a GPS receiver.

The load sensors are configured to monitor a load weight of the crops in the trailer. The moisture sensors are configured to monitor a moisture content of the crops in the trailer. Using the load weight and moisture content values, the vehicle generates an estimated crop yield. In one example, the estimated load weight and moisture content values are sent via wireless transmission to the remote device. In some embodiments, the remote device is a remote server. In other embodiments, the remote device is a webpage. The remote device calculates the estimated crop yield and posts the estimated value along with the GPS location data on the real-time marketplace for purchase.

Upon purchase of a crop load, ownership immediately transfers to the buyer. For example, ownership is transferred as the harvested crops fall into the trailer. As should be appreciated, the system enables crop loads to be purchased prior to harvest based upon predicted crop yields.

Aspect 1 generally concerns a system that includes a commodity transfer system.

Aspect 2 generally concerns the system of any previous aspect in which the trailer.

Aspect 3 generally concerns the system of any previous aspect in which the trailer configured to collect harvested crops.

Aspect 4 generally concerns the system of any previous aspect in which the trailer is configured to collect harvested crops from a combine.

Aspect 5 generally concerns the system of any previous aspect in which the trailer includes a moisture sensor configured to detect a moisture content of the crops.

Aspect 6 generally concerns the system of any previous aspect in which the trailer has landing gear and a motor configured to automatically extend and retract the landing gear upon detection of the vehicle.

Aspect 7 generally concerns the system of any previous aspect in which the landing gear includes one or more large-footprint pads configured to prevent trailer sinking.

Aspect 8 generally concerns the system of any previous aspect in which the trailer includes one or more retractable wheels.

Aspect 9 generally concerns the system of any previous aspect in which the wheels are configured to retract after the trailer is hooked to the vehicle to reduce compaction.

Aspect 10 generally concerns the system of any previous aspect in which the trailer includes an automatic tarp system configured to open and close based on commands from the vehicle.

Aspect 11 generally concerns the system of any previous aspect in which the trailer includes one or more sensors configured to detect tarp position.

Aspect 12 generally concerns the system of any previous aspect in which the trailer includes a rotating rear door for crop removal.

Aspect 13 generally concerns the system of any previous aspect in which the trailer includes one or more sensors configured to detect rear door position.

Aspect 14 generally concerns the system of any previous aspect in which the trailer includes a dump hoist for crop removal.

Aspect 15 generally concerns the system of any previous aspect in which the trailer includes an on-board controller configured to monitor the door sensors and tarp sensors to detect load tampering.

Aspect 16 generally concerns the system of any previous aspect in which the trailer includes a Real-time Kinematic Positioning Global Positioning System (RTK GPS).

Aspect 17 generally concerns the system of any previous aspect in which the RTK GPS is configured to use the trailer as a base station for sending real-time corrections to the vehicle.

Aspect 18 generally concerns the system of any previous aspect in which the trailer includes one or more electrically controlled grain hoppers configured to open and close based on commands from the vehicle.

Aspect 19 generally concerns the system of any previous aspect in which the combine.

Aspect 20 generally concerns the system of any previous aspect in which the combine includes harvesting machine that heads, threshes, and/or cleans grain while moving over a field.

Aspect 21 generally concerns the system of any previous aspect in which the vehicle.

Aspect 22 generally concerns the system of any previous aspect in which the vehicle is detachably coupled to the trailer to move the trailer.

Aspect 23 generally concerns the system of any previous aspect in which the vehicle includes a hitch.

Aspect 24 generally concerns the system of any previous aspect in which the vehicle is at least a level 4 autonomous vehicle configured autonomously move the trailer to and from the combine.

Aspect 25 generally concerns the system of any previous aspect in which the vehicle is configured to fully support the weight of the trailer to prevent trailer ground contact.

Aspect 26 generally concerns the system of any previous aspect in which the vehicle includes a flat-bed type trailer support system configured to slide beneath the trailer during an autonomous trailer hooking and dropping process.

Aspect 27 generally concerns the system of any previous aspect in which the vehicle and trailer include one or more sensors, channels, and/or rollers configured to facilitate autonomous hooking and dropping of the trailer.

Aspect 28 generally concerns the system of any previous aspect in which the vehicle includes a load sensor configured to detect a loading pattern of the crops in the trailer.

Aspect 29 generally concerns the system of any previous aspect in which the vehicle includes a conveyor system configured to receive grain from the hoppers and transport grain throughout the vehicle.

Aspect 30 generally concerns the system of any previous aspect in which the vehicle includes an auger configured to automatically transport grain from the conveyor system into a grain bagger.

Aspect 31 generally concerns the system of any previous aspect in which the vehicle and trailer communicate via telemetry to control the automatic hooking and dropping and automatic fill of the grain bagger.

Aspect 32 generally concerns the system of any previous aspect in which the harvesting system having a trailer configured to collect harvested crops from a combine and a vehicle detachably coupled to the trailer to move the trailer.

Aspect 33 generally concerns the system of any previous aspect in which the real-time marketplace for crop transfer based on an estimated crop load weight, moisture content, and location information.

Aspect 34 generally concerns the system of any previous aspect in which the crop ownership transfer is conferred to a purchasing customer upon movement of a crop from a field into a trailer.

Aspect 35 generally concerns the system of any previous aspect in which the trailer includes a load sensor configured to detect a load weight of the crops in the trailer.

Aspect 36 generally concerns the system of any previous aspect in which the load sensor sends estimated load weight information to the remote device.

Aspect 37 generally concerns the system of any previous aspect in which the trailer includes a moisture sensor configured to detect a moisture content of the crops in the trailer.

Aspect 38 generally concerns the system of any previous aspect in which the moisture sensor sends estimated moisture content information to the remote device.

Aspect 39 generally concerns the system of any previous aspect in which the trailer includes a Global Positioning System (GPS) receiver.

Aspect 40 generally concerns the system of any previous aspect in which a remote device receives trailer location information via a GPS receiver for real-time trailer location tracking

Aspect 41 generally concerns the system of any previous aspect in which the marketplace includes a remote device having a real-time job board for crop hauling to customer.

Aspect 42 generally concerns the system of any previous aspect in which the real-time job board displays available crop load pickup and drop off locations.

Aspect 43 generally concerns the system of any previous aspect in which the real-time job board matches drivers with available loads via a job bidding system.

Aspect 44 generally concerns the system of any previous aspect in which the real-time job board matches drivers with available loads via a flat rate payment system.

Aspect 45 generally concerns the system of any previous aspect in which the remote device is a remote server.

Aspect 46 generally concerns the system of any previous aspect in which the remote device calculates an estimated crop yield based on load weight and moisture content information.

Aspect 47 generally concerns the system of any previous aspect in which the crop receiving facility.

Aspect 48 generally concerns the system of any previous aspect in which the method.

Aspect 49 generally concerns the system of any previous aspect in which the method of operating the system.

Aspect 50 generally concerns the system of any previous aspect in which the driver scans trailer with an app to verify trailer identity.

Aspect 51 generally concerns the system of any previous aspect in which the app directs driver to nearest crop receiving facility for trailer drop off.

Aspect 52 generally concerns the system of any previous aspect in which the driver uses app to confirm trailer drop off at crop receiving facility.

Aspect 53 generally concerns the system of any previous aspect in which the app controls trailer landing gear.

Aspect 54 generally concerns the system of any previous aspect in which the app directs driver to pick up empty trailer at crop receiving facility.

Aspect 55 generally concerns the system of any previous aspect in which the mule scans trailer to verify trailer identity.

Aspect 56 generally concerns the system of any previous aspect in which the mule backs under trailer, commands landing gear to raise, and engages a kingpin of the trailer.

Aspect 57 generally concerns the system of any previous aspect in which the mule lifts the trailer off of the ground and supports the full weight of the trailer.

Aspect 58 generally concerns the system of any previous aspect in which the mule travels a predetermined path to a waiting storage container.

Aspect 59 generally concerns the system of any previous aspect in which the storage container is a grain bag.

Aspect 60 generally concerns the system of any previous aspect in which the mule includes an auger.

Aspect 61 generally concerns the system of any previous aspect in which the mule connects the auger to the grain bag via a quick attach mechanism.

Aspect 62 generally concerns the system of any previous aspect in which the mule includes a conveyor system.

Aspect 63 generally concerns the system of any previous aspect in which the mule includes one or more hoppers.

Aspect 64 generally concerns the system of any previous aspect in which the mule commands hopper doors to open and conveyor system to activate.

Aspect 65 generally concerns the system of any previous aspect in which the grain flows from the hopper along the conveyor and into the grain bag.

Aspect 66 generally concerns the system of any previous aspect in which the mule includes crab steering capabilities.

Aspect 67 generally concerns the system of any previous aspect in which the mule disconnects from grain bag and returns the trailer to the depot once the trailer is emptied.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a dump mule carrying a trailer.

FIG. 2 is a perspective view of the dump mule carrying the trailer of FIG. 1.

FIG. 3 is a front view of the dump mule carrying the trailer of FIG. 1.

FIG. 4 is a side view of the trailer of FIG. 1.

FIG. 5 is a perspective view of the dump mule of FIG. 1.

FIG. 6 is a perspective view of the dump mule of FIG. 5 without wheels.

FIG. 7 is a perspective view of the dump mule of FIG. 5 without wheels.

FIG. 8 is a top view of the dump mule of FIG. 5 without wheels.

FIG. 9 is a rear view of the dump mule of FIG. 5 without wheels.

FIG. 10 is a side view of a trailer loading event.

FIG. 11 is a front view of the trailer loading event of FIG. 10.

FIG. 12 is a side view of a crop unloading event.

FIG. 13 is a diagrammatic view of a harvesting system.

FIG. 14 is a flowchart of a crop transfer method.

FIG. 15 is a flowchart of the harvesting system of FIG. 13.

FIG. 16 is a flowchart of a depot construction method.

FIG. 17 is a flowchart of a trailer drop off method.

FIG. 18 is a flowchart of a trailer pick up method.

FIG. 19 is a flowchart of a load matching system.

FIG. 20 is a flowchart of a storage transfer method.

FIG. 21 is a flowchart of a mule pick up process.

FIG. 22 is a flowchart of a trailer unloading event.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

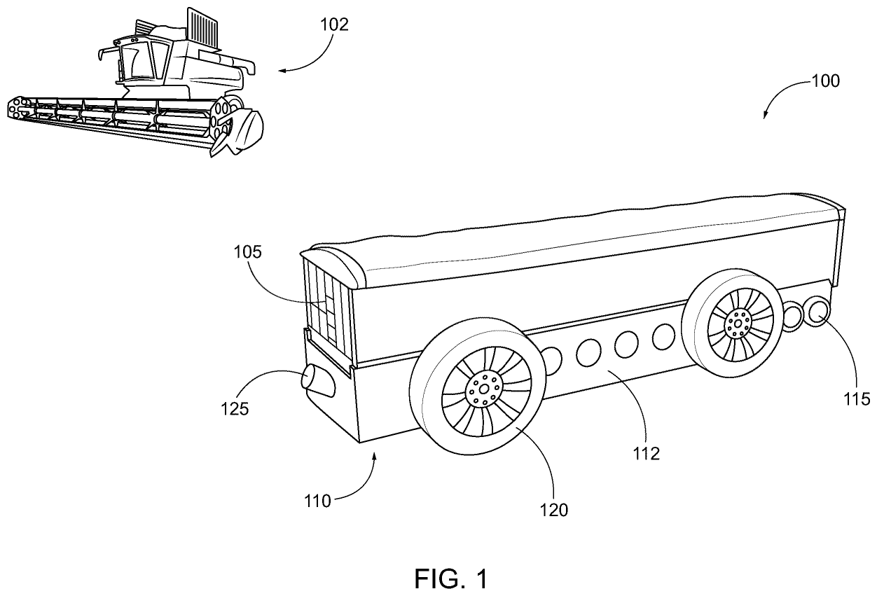

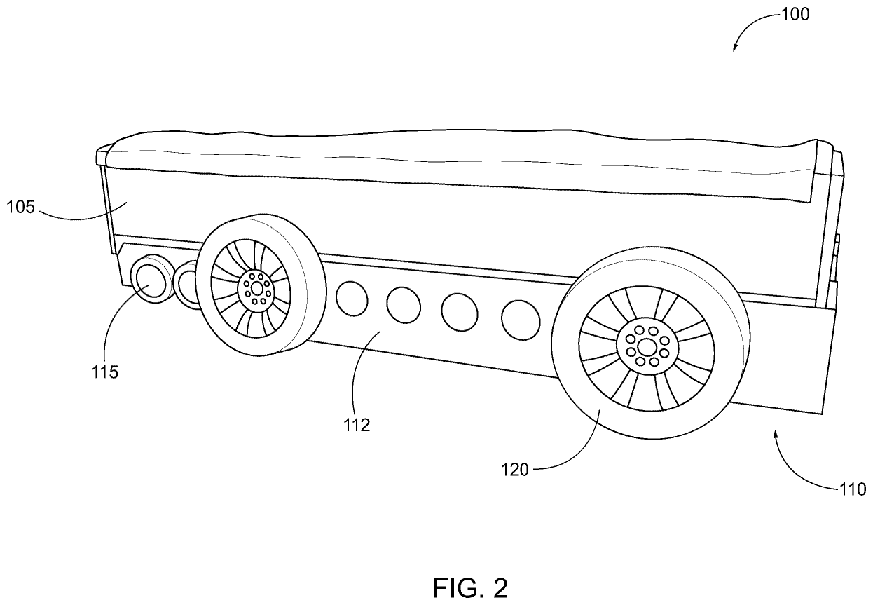

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

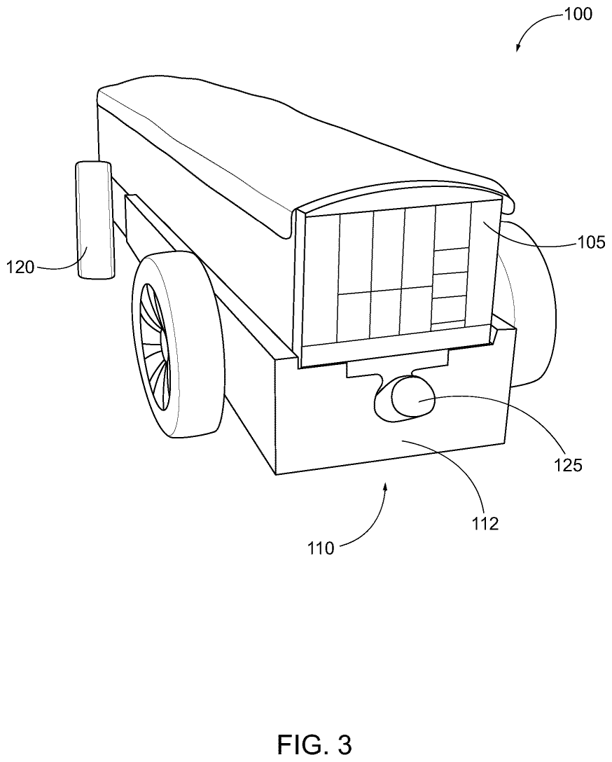

FIGS. 1, 2, and 3 show an example of a harvesting system 100. The harvesting system 100 includes a combine 102, a trailer 105, and a vehicle 110, commonly referred to as a mule 112. The trailer 105 includes one or more trailer wheels 115. The vehicle 110 or mule 112 has one or more mule wheels 120 and an auger 125. As can be seen, the mule 112 supports the entire weight of the trailer 105 to mitigate soil compaction.

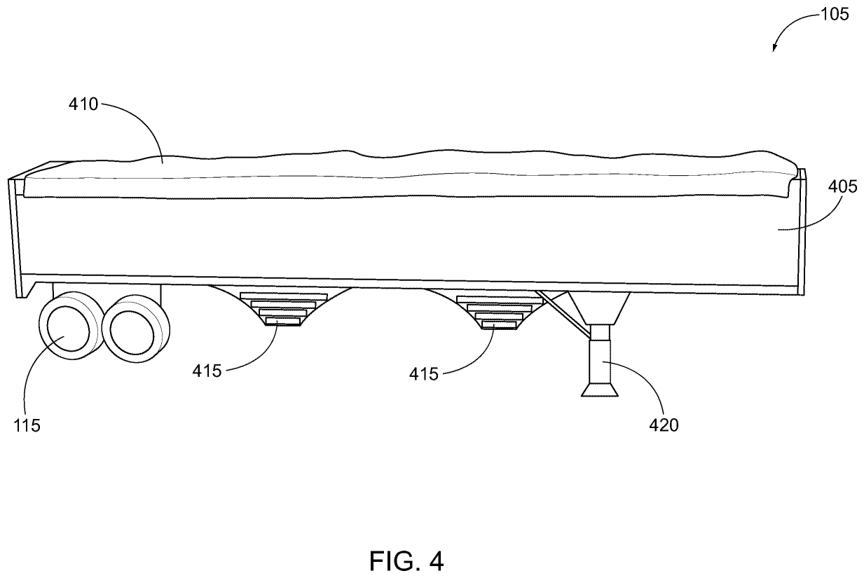

FIG. 4 shows an example of the trailer 105. The trailer 105 is shown to further include a body 405, a tarp 410, one or more hopper 415, and landing gear 420. The trailer wheels 115, tarp 410, hopper 415, and landing gear 420 are all configured to work automatically based on wireless communication between the trailer 105 and the vehicle 110. For example, the mule 112 is configured to issue commands to the trailer 105 so as to automatically retract or deploy the landing gear 420 of the trailer 105. The mule 112 further issues commands to the trailer 105 for automatically retracting or deploying the trailer wheels 115. The mule 112 also communicates with the trailer 105 so as to automatically open or close the hopper 415. Similarly, the trailer 105 can automatically open and close the tarp 410 based on a fill level of the trailer 105.

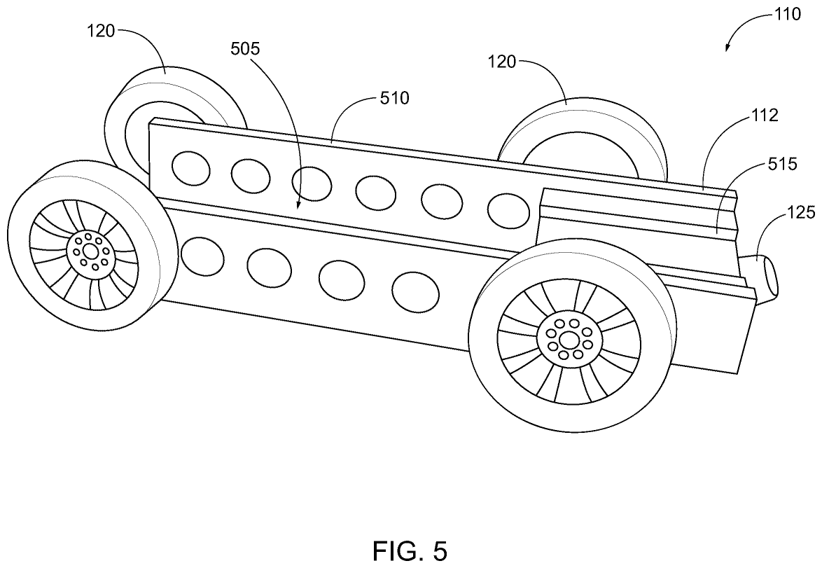

FIG. 5 shows an example of the mule 112 including the mule wheels 120. As shown, the mule 112 has a channel 505, one or more sidewalls 510 that define the channel 505, and a coupling deck conveyor 515. The sidewalls 510 of the channel 505 position the body 405 of the trailer 105 properly on the vehicle 110. The coupling deck conveyor 515 and auger 125 work together to move the crops from within the trailer 105 into a holding tank/grain bag.

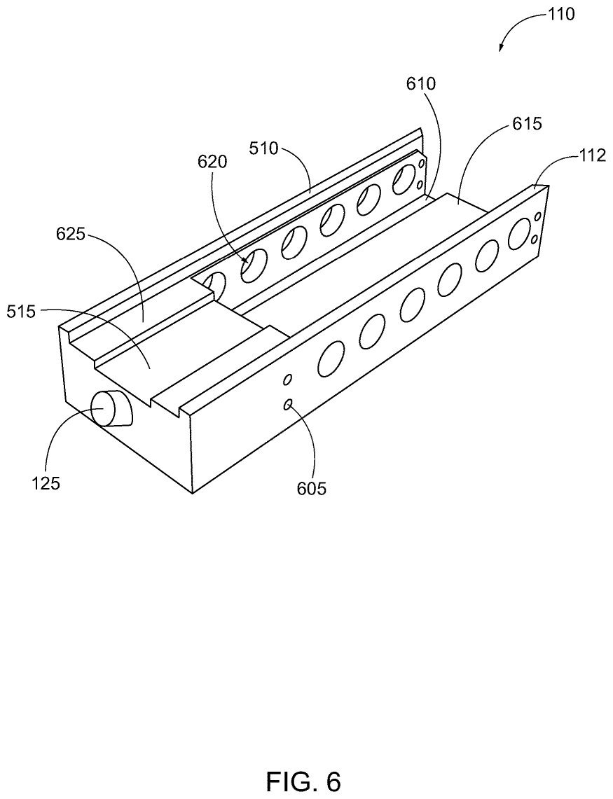

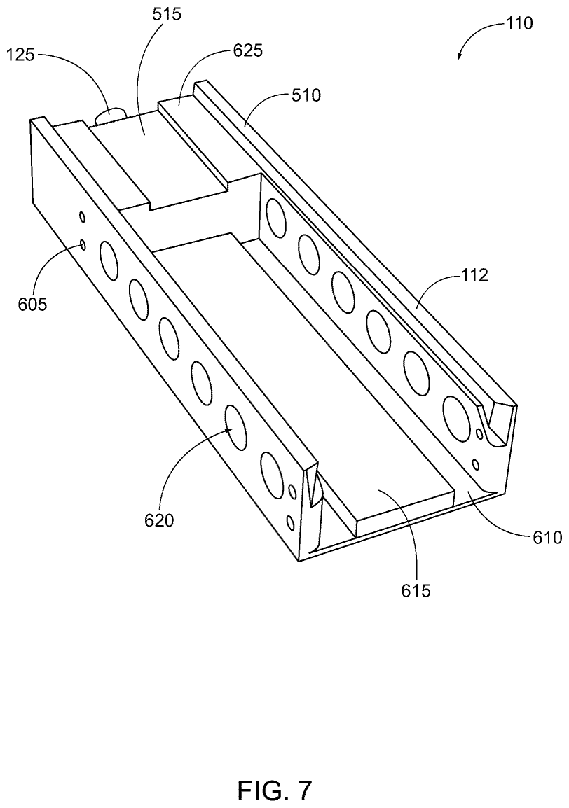

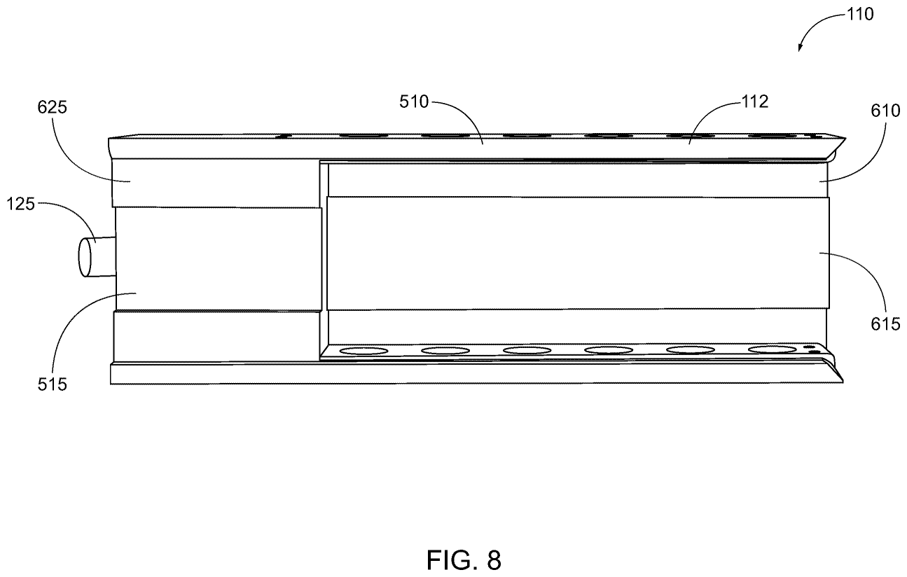

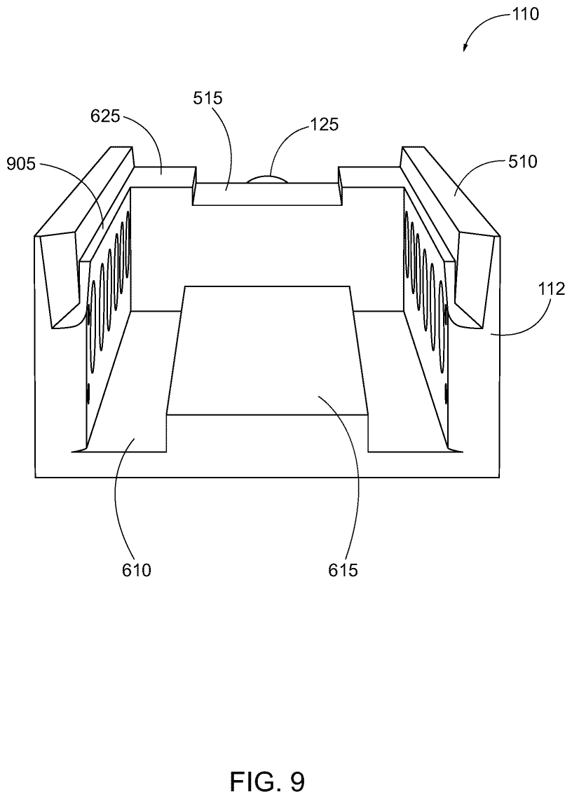

FIGS. 6, 7, 8, and 9 are alternate views of the mule 112, without the mule wheels 120 attached. Referring to FIG. 6, the sidewalls 510 of the mule 112 define one or more wheel mounting holes 605 where the mule wheels 120 are mounted. The mule 112 has a wheel deck 610 and a wheel deck conveyor 615 mounted to the wheel deck 610. The sidewalls 510 define one or more witness holes 620 configured to allow a farmer to watch the trailer unloading/loading process. The coupling deck conveyor 515 is mounted to a coupling deck 625 of the mule 112. The coupling deck 625 of the vehicle 110 feeds crops via the coupling deck conveyor 515 directly into the auger 125. As shown in FIG. 9, the sidewalls 510 define one or more trailer guides 905. The trailer guides 905 act as rails to guide a front portion of the trailer 105 into the mule 112 during loading.

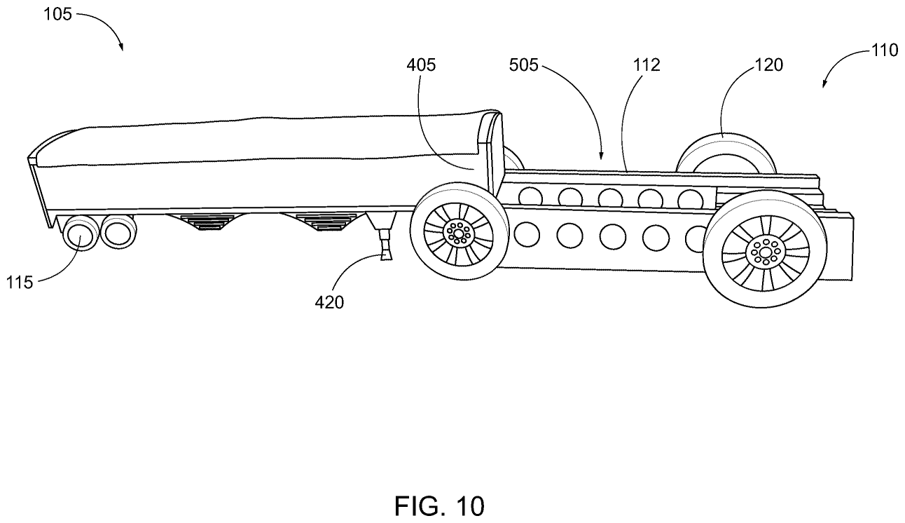

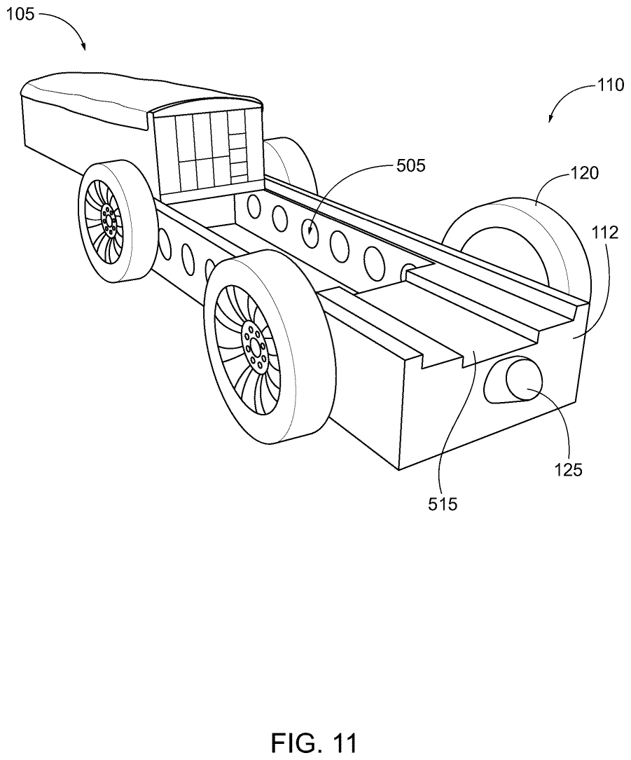

FIGS. 10 and 11 illustrate an example of the trailer 105 being loaded onto the mule 112. During loading, the mule 112 begins by backing under the front of the trailer 105. As the vehicle 110 backs further under the trailer 105, the vehicle 110 sends a command for the trailer 105 to automatically raise the landing gear 420. At this stage, the mule 112 continues to back under the trailer 105 as the trailer 105 slides along the trailer guides 905. Once the vehicle 110 is fully under the trailer 105 (see e.g., FIGS. 1, 2, and 3), the vehicle 110 commands the trailer 105 to raise the trailer wheels 115. At this point, the mule 112 supports the entire weight of the trailer 105.

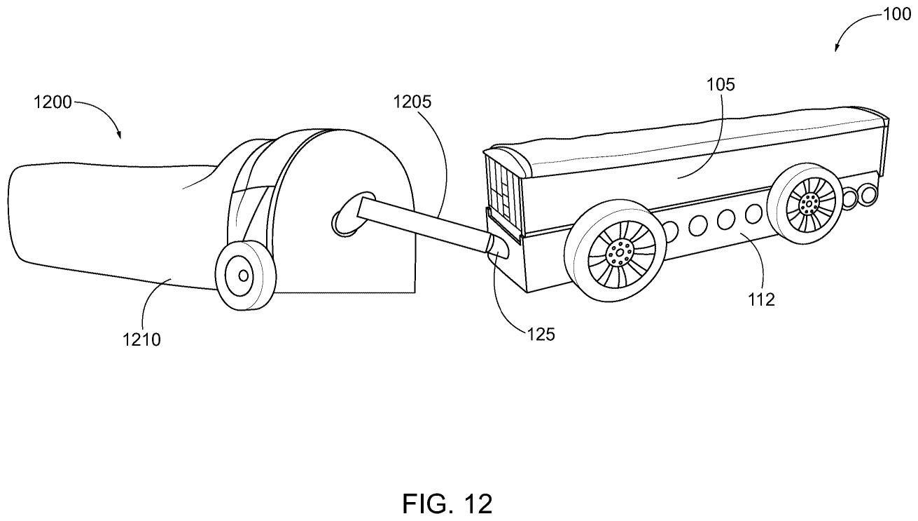

The next stage is represented in FIG. 12. The vehicle 110 drives to a grain bagger 1200. Once arriving at the grain bagger 1200, the mule 112 mates with the grain bagger 1200 via the auger 125 and chute 1205. At this stage, the mule 112 commands the trailer 105 to open the hopper 415, thus releasing grain onto the wheel deck conveyor 615. The mule 112 then powers the wheel deck conveyor 615 and grain begins to transport from the wheel deck conveyor 615 to the coupling deck conveyor 515. From the coupling deck conveyor 515, the grain transfers into the auger 125 and through the chute 1205 into a grain bag 1210 of the grain bagger 1200 for storage. After the trailer 105 is emptied, the mule 112 pulls away from the grain bagger 1200, unloads the trailer 105 and picks up a new, full trailer 105.

As noted before, the vehicle 110 and trailer 105 system has been developed to reduce soil compaction. To reduce compaction, the vehicle 110 in one example includes a continuous track propulsion system. The continuous track system distributes a vehicle 110 weight over an increased surface area. As should be appreciated, distributing the vehicle 110 weight reduces soil compaction. The vehicle 110 in one form further includes a hitch configured to receive the trailer 105. In one variation, the hitch is a fifth wheel type hitch, and in another variation, the trailer 105 is a standard semi-trailer. The trailer 105 in one example is a hopper 415 type trailer 105, but other types of trailers 105 can be used.

The fifth wheel hitch is configured to distribute a trailer 105 load weight evenly onto the vehicle 110 to decrease compaction. The hitch includes an automatic actuator to hook and drop the trailer 105 from the vehicle 110. In one example, the hitch further includes one or more sensors. The sensors are configured to monitor the hook and drop process to confirm completion. The trailer 105 includes modified automatic landing gear 420. The landing gear 420 is configured to extend when uncoupled from the vehicle 110 and retract when coupled to the vehicle 110. In one embodiment, the landing gear 420 has a large landing foot. The large landing foot increases surface area to decrease soil compaction. The trailer 105 braking system is self-contained. Meaning, the trailer 105 braking system is not connected to the braking system of the vehicle 110. In one example, the trailer 105 braking system includes an air tank, an electric pump, a battery, and a solenoid valve. The solenoid valve is configured to control a parking brake release through wireless communication with the vehicle 110. The wireless communication is a short-range wireless communication protocol. In one example, the wireless communication protocol is the Bluetooth® protocol. The trailer 105 braking system is configured to activate when the landing gear 420 is extended to prevent activation on the road. In one example, the trailer 105 includes Department of Transportation (DOT) approved high-flotation tires and a central tire inflation system (CTIS). The CTIS allows the tires to be deflated when on soil to mitigate compaction and inflated when on the road to minimize friction and increase fuel savings.

The wireless network is configured to control various aspects of the vehicle 110 and trailer 105. For example, the wireless network is configured to control the operation of the tarp 410 covering the trailer 105. In another example, the wireless network is configured to transmit a video feed of the trailer 105 to an operator. In a further example, the wireless network is configured to control trailer 105 lighting. In yet another example, the wireless network is configured to send trailer 105 position data to the vehicle 110 from a satellite navigation system components, such as using the Global Positioning System (GPS), located on the trailer 105. The position data from the trailer 105 is used by the vehicle 110 to facilitate an automated process whereby the vehicle 110 drops off a loaded trailer 105, connects to the wireless network of an empty trailer 105, and uses the position data to properly hook and remove an empty trailer 105.

In one example, the vehicle 110 is attached to the combine 102 with the tow arm and towed to the field. The tow arm in one form includes one or more sensors. The sensors direct the vehicle 110 to follow the path of the combine 102 under the power of the vehicle 110. Once the operator has reached the crop area, the vehicle 110 is disconnected from the tow arm and the tow arm is stowed under the vehicle 110. To facilitate communication, the vehicle 110 is connected to the combine 102 wirelessly via a dongle connected to an International Organization for Standardization (ISO) bus/diagnostic port of the combine 102. The wireless connection is configured to exchange information about the harvested area, the current yield, and/or the remaining storage space inside the combine 102. In one example, the wireless connection is a long-range wireless network.

As the combine 102 reaches storage capacity, the vehicle 110 moves into position to accept a load from the combine 102. As the vehicle 110 moves to intercept the combine 102 the tarp 410 over the trailer 105 automatically opens to receive the load. Once the vehicle 110 is properly positioned, a command is sent to the combine 102. The command instructs the combine 102 to empty the crop storage into the trailer 105. The combine 102 uses on-the-go dumping in which the combine 102 continues harvesting during the loading or unloading process. The auger 125 arm in one form just swings out while the combine 102 continues to harvest. During the loading process, the vehicle 110 shifts to allow for loading towards the front of the trailer 105 first. The shifting process keeps weight over the tracks of the vehicle 110 to aid in traction control. In one embodiment, the trailer 105 includes one or more load sensors in the suspension. In another embodiment, the trailer 105 includes one or more load sensors in the fifth wheel hitch. The load sensors are configured to monitor the weight of the crops that are loaded into the trailer 105. The weight data is used to adjust the position of the vehicle 110. As was discussed above, the position of the vehicle 110 is based upon balancing the trailer 105 weight. In another example, the trailer 105 further includes one or more paddle sensors. The paddle sensors are configured to monitor the height of the crops in the trailer 105. In one example, the sensors send an alert to the vehicle 110 that the crops have reached a predetermined fill level.

After the trailer 105 is filled, the vehicle 110 transmits a command to the combine 102 to stop loading, pull away, and resume harvesting. If the trailer 105 is full, the vehicle 110 returns to a loading area. As the vehicle 110 moves towards the loading area, the trailer 105 begins to automatically close the tarp 410 to protect the crops. Once the vehicle 110 reaches the loading area, the vehicle 110 activates the landing gear 420 of the trailer 105, activates the parking brakes of the trailer 105, and automatically disconnects from the trailer 105.

In another example, the trailer 105 is an on-road compatible semi-trailer with a pivotable rear door for crop unloading. Alternatively or additionally, the trailer 105 can include a dump hoist. Once more, the mule 112 is configured to lift and fully support the weight of the trailer 105 to prevent trailer 105 ground contact. Most semi-trailers and other road-based trailers 105 are not designed for travelling across farm fields. The wheels of the trailer 105 can compact the soil and even become stuck in mud. By lifting and carrying the trailer 105 across the farm field to combine 102, the vehicle 110 or mule 112 can avoid these as well as other issues.

In one example, the mule 112 is an autonomous vehicle 110 including a flat-bed type trailer 105 support system. The mule 112 in one form has a guidance, navigation, and control (GNC) system for automatic navigation. The mule 112 is configured to slide underneath the trailer 105 during pickup guided by the sensors, channels 505, and/or rollers. The landing gear 420 and trailer wheels 115 of the trailer 105 are configured to automatically retract. To facilitate trailer 105 drop-off and pick-up, the landing gear 420 is configured automatically extend and retract upon detection of the mule 112. For example, during pickup of the trailer 105, the landing gear 420 detects the approaching mule 112 and automatically retracts underneath the trailer 105. Retracting the landing gear 420 clears space to allow the mule 112 to continue to back further under the trailer 105. Once the mule 112 reaches the trailer wheels 115, the mule 112 locks into the trailer 105 and the trailer wheels 115 are retracted. As should be appreciated, after the trailer wheels 115 are retracted the trailer 105 is fully supported by the mule 112. Put differently, the trailer 105 is said to be “floating” (e.g. not in contact with the ground) to reduce soil compaction.

Again, the mule 112 is configured to carry the trailer 105 into the field to collect crops from a combine 102. The load sensors of the trailer 105 are configured to monitor the weight of the crops that are loaded into the trailer 105. The weight data is used to adjust the position of the mule 112. The position of the mule 112 is based upon balancing the weight of the trailer 105. The moisture sensors of the trailer 105 are configured to monitor the moisture content of the harvested crops. In one example, the moisture content and crop weight are used to calculate an expected crop yield.

After the trailer 105 is full, the mule 112 pulls away from the combine 102 and drives to an unloading area. As the mule 112 drives to the unloading area, an automatic tarp 410 is deployed to seal the crop load. In one example, the tarp 410 sensors of the trailer 105 are located on the tarp 410 and/or trailer 105 rear door. The sensors are configured to detect the positon of the tarp 410 and/or rear door. In another example, the sensors are configured to detect tampering with the crop load.

Once arriving in the unloading area, the mule 112 extends the trailer wheels 115, unlocks from the trailer 105, and drives out from underneath the trailer 105. As the mule 112 drives out from underneath the trailer 105 the landing gear 420 is automatically extended. To enable trailer 105 locating tracking, the trailer 105 includes a Global Positioning System (GPS) configured to monitor the status and location of the trailer 105. In one form, the GNC incorporates the GPS, but in other examples, the GNC and GPS are separate and distinct components.

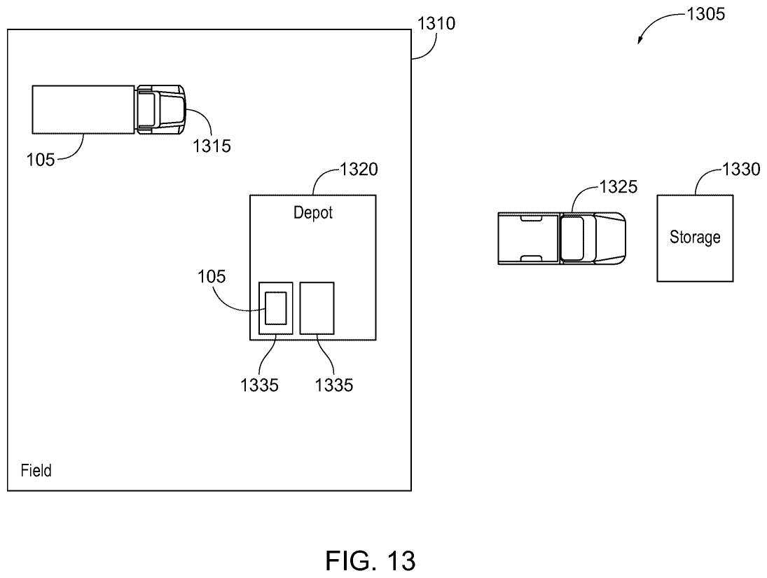

Shown in FIG. 13 is an example of a harvesting system 1305. The harvesting system 1305 includes a field 1310 and a truck 1315 to transport crops from the field 1310 to a depot 1320. The truck 1315 deposits the trailer 105 in one or more predetermined parking spaces 1335. Once the crops are delivered to the parking spaces 1335 at the depot 1320 a mule 1325 transports the crops to a storage device 1330. In one form, the storage device 1330 is the grain bagger 1200.

The depot 1320 is a grain receiving facility that is optimized to handle the massive influx of grain during harvest. Grain elevators usually serve this purpose. Elevators are incredibly expensive and are geographically sparse, leading to long transit times for some farmers, along with long wait times during large and/or wet crops. The depot 1320 is typically established in an open field 1310 at low cost and with minimal labor. Locating depots 1320 closer to farm fields 1310 reduces the time a farmer has to wait for an empty trailer 105 to return. Further, the depots operate with quick turnaround times.

The depot 1320 begins with a clear field 1310, likely a grain field 1310 that was harvested early. The soil is disked and finished to ensure that no stubble remains. Rodenticide is incorporated into the soil. Driveways are paved with stone providing plenty of space for semi trucks 1315 with trailers 105 to maneuver. Cameras and lights are mounted on poles. A mobile office with Internet access and computers is located on-site. Pull-through parking spaces 1335 are marked with reflective paint.

To use the depot 1320, a producer (farmer) leases units of “trailer capacity.”

The driver uses an app to capture a quick response (QR) code of the trailer 105. The app directs the driver to the depot 1320. The driver transports the trailer 105 to the depot 1320. The driver parks in an open spot as assigned by the app. The driver uses the app to confirm delivery. The central system queries the location provided by the GPS of the trailer 105 to confirm the parking space 1335. When clear, the app is enabled to control the landing gear 420 of the trailer 105. The driver uses the app to lower the landing gear 420 when ready. The driver disconnects the air and electrical lines. The driver releases the kingpin and pulls away from the trailer 105.

The app directs the driver to another parking space 1335 to pick up an empty trailer 105. The driver backs into position under the trailer 105. The driver engages the kingpin of the trailer 105. The driver connects the air and electrical lines. The driver inspects the trailer 105, using the app to scan QR codes at key locations. When clear, the app is enabled to control the landing gear 420 of the trailer 105. The driver uses the app to raise the landing gear 420 when ready. The driver departs with the empty trailer 105.

At the beginning of the season, the producer picks up one trailer 105 per capacity units being leased. The producer fills the trailer 105 with grain.

The driver informs the app of preferences such as distance to travel, time available, etc. The app notifies the driver of load/delivery combinations available. The driver selects a load and contract for load delivery. The app directs the driver to the waiting load in a field 1310 or at a depot 1320. The driver drives to the load. The driver follows the appropriate pick-up steps for the load. The app directs the driver to the destination. The driver drives to the destination. The driver follows the appropriate drop-off procedure.

A full load arrives. Drivers are cleared from the pick-up area. (Either by departing or waiting for clearance.) The mule 112 approaches the trailer 105. The mule 112 scans the QR code of the trailer 105 to verify the identity of the trailer 105. The mule 112 lowers to fit under the trailer 105. The mule 112 stops shortly before contacting the landing gear 420. The mule 112 raises enough to engage the outside rails of the trailer 105. The trailer 105 commands the landing gear 420 to raise. The mule 112 continues to drive toward the rear of the trailer 105 as it supports the weight of the trailer 105. The mule 112 stops when the kingpin is engaged. The mule 112 lifts the trailer 105 such that the tires of the trailer 105 no longer touch the ground. When cleared, the mule 112 departs the parking area with the trailer 105. The central system directs the mule 112 along a cleared path to a waiting bagger. The mule 112 drives the path to the bagger. The mule 112 lowers. The mule 112 travels forward so that the auger 125 of the mule 112 goes into the bagger hole and the quick attach engages the bagger. The mule 112 lifts and locks onto the bagger. The mule 112 engages the conveyor/auger system. The trailer 105 directs the hopper 415 traps to open. Grain flows through the traps along the conveyor/auger system into the bag. The mule 112 maintains pressure against the bagger (as measured by sensors), moving away from the bagger as the bag fills. The mule 112 uses crab steering to maintain the desired (straight) path for the bag. In this way, all of the grain is discharged into the bag. The trailer 105 commands the hopper 415 traps to close. The mule 112 disengages the conveyor/auger system. The mule 112 disengages the quick attach lock. The mule 112 lowers the bagger to skids, disengaging it. The mule 112 pulls clear of the bagger. The mule 112 lifts to prepare for transit. The system clears the mule 112 along an exclusive path to a staging area. The mule 112 returns to the staging area.

The system chooses the delivery depot 1320 to optimize for workload, prices, and transit time. The system monitors progress of the inbound trailer 105 to ensure that a parking space 1335 is available. The system monitors drop-offs and coordinate mules 112 so that there is no conflict with trucks 1315.

Baggers include a frame on skids (with sensor reel). Bagger has quick attach points for the augers 125 which also work for skid steers. Manned skid steers bring the baggers to a central location to load bags. The end of the bag is heat sealed by a person.

The baggers are loaded with a strand of temperature sensors. The strand is brought out through the heat sealed end. This strand is connected to a wireless network for monitoring bags. When a bag gets warm, the bag needs to be repaired or emptied.

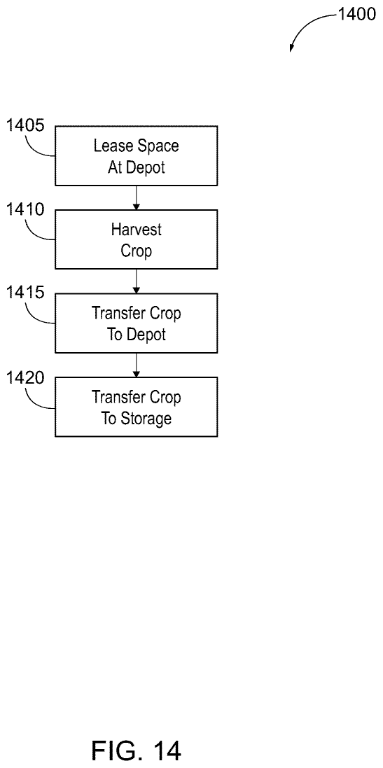

FIG. 14 illustrates a flowchart 1400 showing an overview of the harvest process. At stage 1405 a producer leases the parking spaces 1335 at the depot 1320 location. In some examples, the producer may lease more than one parking spaces 1335. The leased space enables the producer to drop off full trailer 105 at the depot 1320 and pick up empty trailer 105 at the depot 1320. As should be appreciated, this speeds up the crop unloading process and increases harvest efficiency. At stage 1410 the producer harvests the crop and loads a trailer 105 with the harvested crops. At stage 1415 the full trailer 105 is transported to the depot 1320 and the trailer 105 is parked in the leased parking spaces 1335. At stage 1420 the full trailer 105 is picked up by a mule 1325 and transported to a storage container where the crops are emptied into the storage container. Following this, the emptied trailer 105 is returned to the depot 1320.

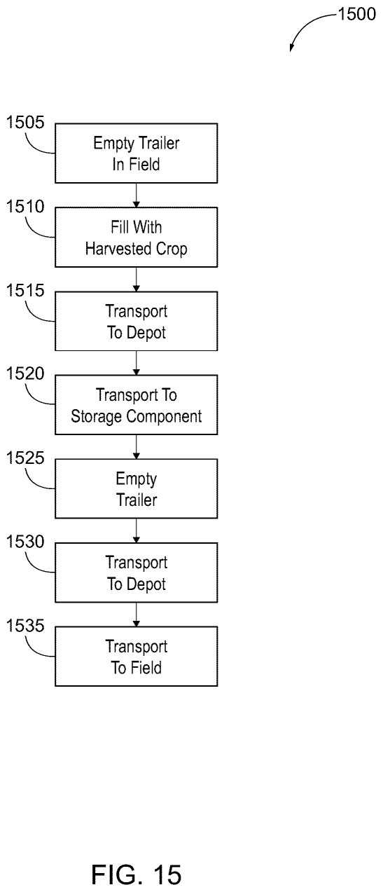

FIG. 15 shows a flowchart 1500 depicting a more detailed overview of the harvest process. At stage 1505 an empty 150 is waiting to be filled with harvested crop. At stage 1510, the trailer 105 is filled with harvested crops via a combine, mule, or other agricultural device. At stage 1515 the filled trailer 105 is transported to the depot 1320. At stage 1520 the filled trailer 105 is transported to the storage area. At stage 1525 the trailer 105 is emptied into the storage component. At stage 1530 the emptied trailer 105 is transported back to the depot 1320. At stage 1535 the empty trailer 105 is picked up from the depot 1320 and transported to the field 1310 to restart the process at stage 1505.

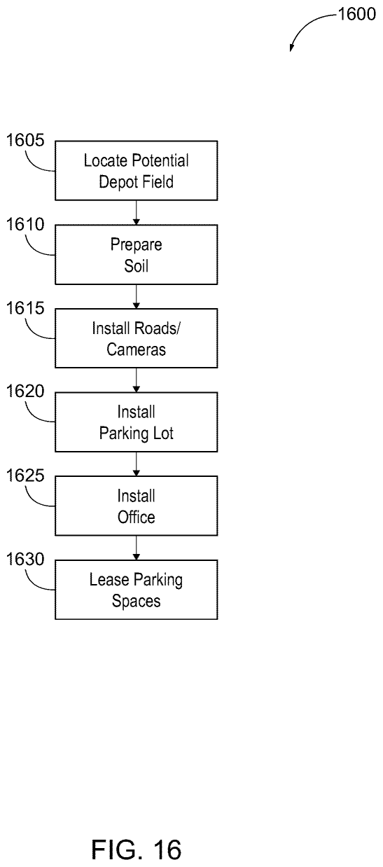

FIG. 16 shows a flowchart 1600 depicting a depot 1320 construction process. At stage 1605 a location for the depot 1320 is determined. For example, the depot 1320 location may be a field 1310 that has already been harvested. At stage 1610 the soil is prepared for construction of the depot 1320. For example, the soil is tilled and finished. The soil may also be treated with rodenticide. At stage 1615 gravel roads are installed leading to the depot 1320 to enable commercial vehicles and large trailers to reach the depot without concern over traction and/or getting stuck. At stage 1615 light poles and cameras are also installed to monitor the depot 1320. At stage 1620 a parking lot and parking lines are installed. In some examples, the parking spaces 1335 are numbered to indicate proper parking locations to drivers. At stage 1625 a mobile office is added adjacent the parking lot. At stage 1630 the parking spaces 1335 are leased to producers for use during harvest. As should be appreciated, the depot 1320 is able to be constructed/torn down with minimal damage to the field 1310.

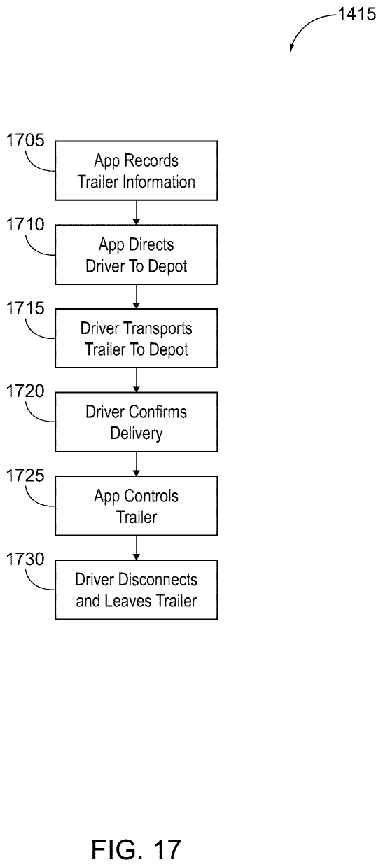

Depicted in FIG. 17 is a detailed example of stage 1415. At stage 1705 the driver uses a mobile application (app) to scan one or more quick response (QR) codes around the trailer 105. At stage 1710, the app uses trailer location information to locate the nearest depot 1320 for drop off and directs the driver to the depot 1320. At stage 1715 the driver transports the full trailer 105 to the depot 1320 and parks in the parking spaces 1335 assigned by the app. At stage 1720 the driver uses the app to confirm delivery of the trailer 105. The app then uses the trailer location information to confirm delivery. At stage 1725 the app controls the trailer 105 and lowers the landing gear 420. At stage 1730, the driver disconnects from the trailer 105 and leaves the full trailer in the parking spaces 1335.

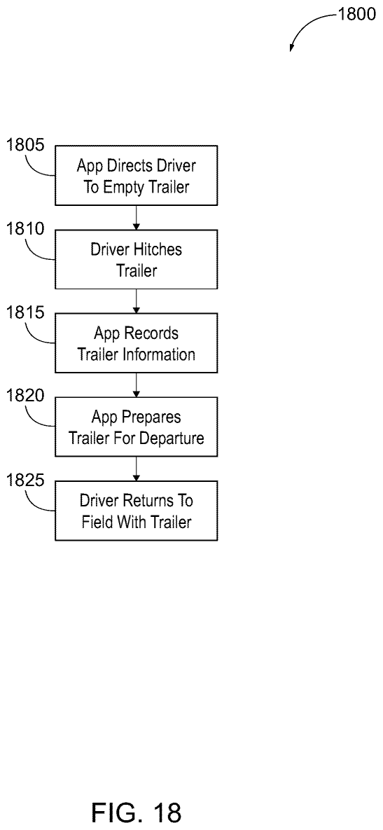

Shown in FIG. 18 is a flowchart 1800 for an example of an empty trailer pick up process. Following stage 1730 of FIG. 17 the driver is directed to another parking spaces 1335 with an empty trailer via the app as shown at stage 1805. At stage 1810 the driver hitches and connects to the empty trailer. At stage 1815, the driver uses the app to scan trailer QR codes and record trailer information. At stage 1820, the app takes control of the trailer and raises the landing gear 420. At stage 1825, the driver transports the empty trailer to a field 1310 to be filled with harvested crops.

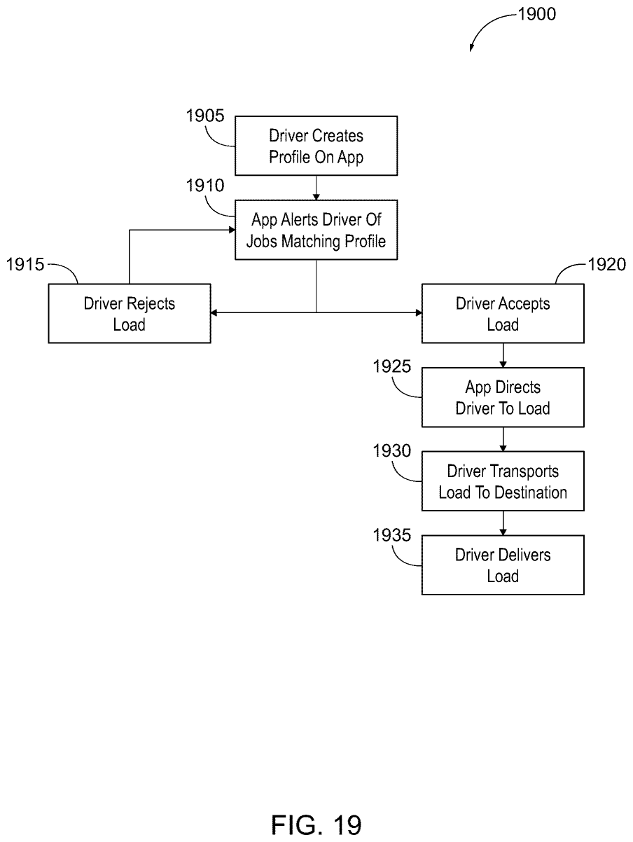

FIG. 19 illustrates an example of a flowchart 1900 for a driver load notification process. At stage 1905 the driver creates a driver profile on the app. The profile includes information on driver experience level, desired travel distance, desired load type, desired payment for load transit, and/or other driver information. At stage 1910 the driver begins to get app alerts whenever a load matching the driver profile is listed as needing transport. At stage 1915 the driver rejects the load as undesirable and returns to stage 1910. At stage 1920 the driver accepts a desirable load via the app. At stage 1925 the app directs the driver to the accepted load for pick up. At stage 1930 the driver picks up the load and transports the load to the destination. At stage 1930 the driver delivers the load to the destination and confirms delivery via the app.

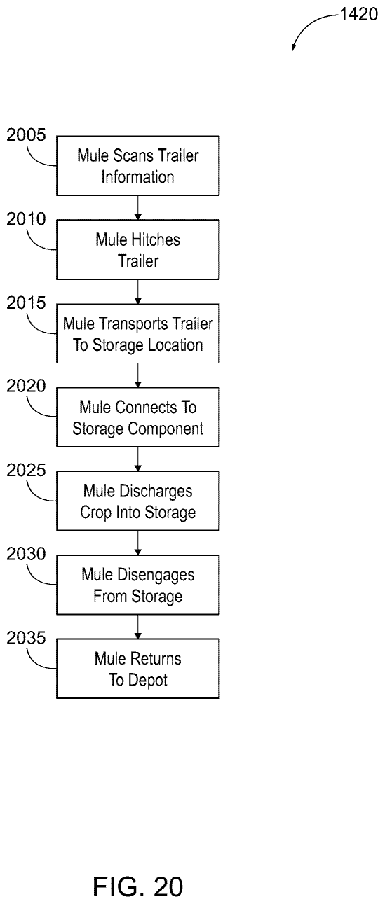

FIG. 20 shows a detailed view of stage 1420. At stage 2005 a mule 1325 approaches a parked trailer 105 and scans the trailer via QR codes to record trailer information. At stage 2010 the mule 1325 begins to back underneath the trailer 105 until contacting the landing gear 420. At this time, the mule 1325 commands the landing gear 420 to raise and backs under the trailer 105 up to the trailer wheels 115. The mule 1325 then raises up to lift the trailer 105 off of the ground. At this time, the mule 1325 supports the entire weight of the trailer 105. At stage 2015, the mule 1325 transports the trailer 105 to the storage location. At stage 2020 the mule 1325 connects to the storage container, via an auger 125. In one example, the storage container is a grain bagger 1200 with a quick attach fitting. At stage 2025 the mule 1325 commands the trailer 105 to open one or more hopper 415 doors and release the crops onto the conveyor of the mule 1325. The conveyor then transports the crops through the auger 125 into the storage container. During loading, the mule 1325 may utilize crab steering to maintain proper positioning of the auger 125 and storage container. At stage 2030 the mule 1325 commands the hopper 415 doors to close and the conveyor to shut off. The mule 1325 also disengages the auger 125 from the storage container. At stage 2035 the mule 1325 returns to the depot 1320 with the empty trailer and places the trailer 105 back into the assigned parking spaces 1335.

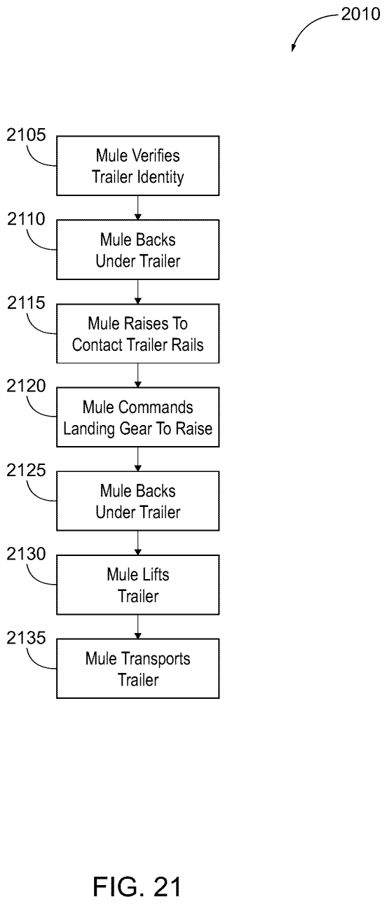

FIG. 21 depicts stage 2010 in more detail. At stage 2105 the mule 1325 scans the trailer 105 via QR codes to verify the trailer identity. At stage 2110 the mule 1325 lowers and beings to back under the trailer 105. At stage 2115 the mule 1325 raises to contact the rails of the trailer 105. At stage 2120 the mule 1325 commands the trailer landing gear 420 to raise as the mule 1325 continues to back under the trailer 105 as shown in stage 2125. At stage 2130 the mule 1325 reaches the trailer wheels 115 and begins to raise up until the trailer 105 is no longer in contact with the ground. At this time, the mule 1325 supports the entire weight of the trailer 105. At stage 2135 the mule 1325 transports the trailer 105 to the storage container.

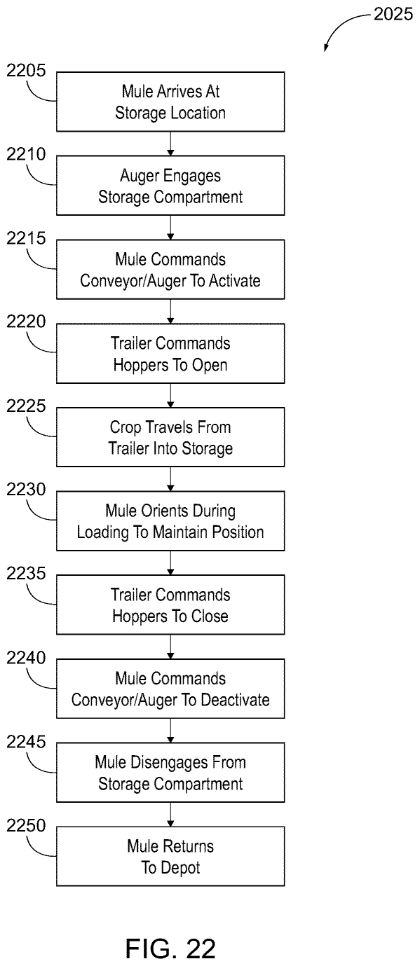

FIG. 22 depicts stage 2025 in more detail. At stage 2205 the mule 1325 arrives at the storage location with the full trailer 105. At stage 2210 the auger 125 of the mule 1325 engages the storage compartment. At stage 2215 the mule 1325 commands the conveyors and auger 125 to activate. At stage 2220 the trailer commands the hopper 415 to open. At stage 2225 the crops travel from the trailer 105 onto the conveyor and into the storage compartment. At stage 2230 the mule 1325 orients itself during loading to maintain proper loading positioning. The mule 1325 may utilize crab steering to maintain position. At stage 2235 the trailer 105 commands the hopper 415 to close once the trailer 105 is emptied. At stage 2240 the mule 1325 commands the conveyor and auger 125 to deactivate. At stage 2245 the mule 1325 disengages from the storage compartment. At stage 2250 the mule 1325 returns to the depot 1320 with the empty trailer and drops off the trailer 105 in the assigned parking spaces 1335.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Brake” generally refers to a device for arresting and/or preventing the motion of a mechanism usually via friction, electromagnetic, and/or other forces. Brakes for example can include equipment in automobiles, bicycles, or other vehicles that are used to slow down and/or stop the vehicle. In other words, a brake is a mechanical device that inhibits motion by absorbing energy from a moving system. The brake can be for example used for slowing or stopping a moving vehicle, wheel, and/or axle, or to prevent its motion. Most often, this is accomplished by friction. Types of brakes include frictional, pressure, and/or electromagnetic type braking systems. Frictional brakes for instance can include caliper, drum, and/or disc drakes. Electromagnetic braking systems for example can include electrical motor/generators found in regenerative braking systems.

“Cellular Device” generally refers to a device which sends or receives data, and/or sends or receives telephone calls using a cellular network. Cellular devices may thus be characterized as nodes in a communications link operating as an originating and/or final receiving node. A cellular device transmits to and receives from a cellular transceiver located in the cell (e.g. at a base unit or “cell tower.”) Radio waves are generally used to transfer signals to and from the cellular device on a frequency that is specific (but not necessarily unique) to each cell. A cellular device may include a computer with memory, processor, display device, input/output devices, and so forth, and thus may be used as, and referred to as, a personal computing device.

“Class 8 Trailer” means, per the U.S. Department of Transportation Heavy Duty Classification, a trailer or trailers pulled behind a truck wherein the gross vehicle weight rating is above 33,000 pounds (14,969 kg).

“Combine” generally refers to a harvesting machine that heads, threshes, and/or cleans grain while moving over a field.

“Communication Link” generally refers to a connection between two or more communicating entities and may or may not include a communications channel between the communicating entities. The communication between the communicating entities may occur by any suitable means. For example, the connection may be implemented as an actual physical link, an electrical link, an electromagnetic link, a logical link, or any other suitable linkage facilitating communication. In the case of an actual physical link, communication may occur by multiple components in the communication link configured to respond to one another by physical movement of one element in relation to another. In the case of an electrical link, the communication link may be composed of multiple electrical conductors electrically connected to form the communication link. In the case of an electromagnetic link, elements of the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum. In the case of a logical link, the communication links may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing. A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network interface to perform various network communications upon request. A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. A computer may include one or more physical processors or other computing devices or circuitry, and may also include any suitable type of memory. A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer. The concept of “computer” and “processor” within a computer or computing device also encompasses any such processor or computing device serving to make calculations or comparisons as part of a disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

“Conveyor” is used in a broad sense to generally refer to a mechanism that is used to transport something, like an item, box, container, and/or SKU. By way of non-limiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“Couple” or “Coupled” generally refers to an indirect and/or direct connection between the identified elements, components, and/or objects. Often the manner of the coupling will be related specifically to the manner in which the two coupled elements interact.

“Fifth-Wheel Coupling” generally refers to a horse-shaped device on a towing vehicle, such as a tractor or truck, that is configured to receive a kingpin on a trailer, such as a semitrailer or camper trailer, so as to provide a mechanical link between the towing vehicle and the trailer. For example, some camper trailers use a fifth-wheel configuration, requiring the fifth-wheel coupling to be installed in the bed of a pickup truck. As the connected truck turns, the downward-facing surface of the trailer with the kingpin at the center rotates against an upward-facing surface of the fixed fifth wheel coupling that does not rotate. To reduce friction, grease is sometimes applied to this surface of the fifth wheel coupling. This fifth-wheel configuration is sometimes called a turn-table in Australia and New Zealand. Typically, but not always, the fifth-wheel coupling is located directly above an axle or between the axles of a vehicle.

“Flat” generally refers to an object having a broad level surface but with little height.

“Guidance, Navigation, and Control (GNC) System” generally refers to a physical device, a virtual device, and/or a group of devices configured to control the movement of vehicles, such as automobiles, automated guided vehicles, ships, aircraft, drones, spacecraft, and/or other moving objects. GNC systems are typically configured to determine a desired path of travel or trajectory of the vehicle from the vehicle's current location to a designated target, as well as desired changes in velocity, rotation, and/or acceleration for following the path. The GNC system can include and/or communicate with sensors like compasses, GPS receivers, Loran-C, star trackers, inertial measurement units, altimeters, environmental sensors, and the like. At a given time, such as when the vehicle is travelling, the GNC system is configured to determine the location (in one, two, or three dimensions) and velocity of the vehicle. For example, the GNC system is able to calculate changes in position, velocity, attitude, and/or rotation rates of a moving vehicle required to follow a certain trajectory and/or attitude profile based on information about the state of motion of the vehicle. The GNC system is able to maintain or change movement of the vehicle by manipulating forces by way of vehicle actuators, such as steering mechanisms, thrusters, flaps, etc., to guide the vehicle while maintaining vehicle stability. GNC systems can be found in autonomous or semi-autonomous vehicles.

“Inertial Measurement Unit” or “IMU” generally refers to a device that measures and reports a body's specific force, angular rate, and sometimes the magnetic field surrounding the body. The IMU typically, but not always, includes one or more accelerometers and gyroscopes, and sometimes magnetometers when the surrounding magnetic fields are measured. IMUs are typically (but not always) self-contained systems that measure linear and angular motion usually with a triad of gyroscopes and triad of accelerometers. An IMU can either be gimballed or strapdown, outputting the integrating quantities of angular velocity and acceleration in the sensor/body frame. They are commonly referred to in literature as the rate-integrating gyroscopes and accelerometers. IMUs typically can be used in a wide variety of circumstances such as to maneuver vehicles, aircraft, and/or spacecraft as well as in cellphones and virtual reality glasses. The accelerometers in IMUs can include mechanical and/or electronic type accelerometers, and the gyroscopes in IMUs can include mechanical and/or electronic type gyroscopes.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices. Computers coupled to a network may be referred to as “nodes” or as “hosts” and may originate, broadcast, route, or accept data from the network. Nodes can include any computing device such as personal computers, phones, and servers as well as specialized computers that operate to maintain the flow of data across the network, referred to as “network devices”. Two nodes can be considered “networked together” when one device is able to exchange information with another device, whether or not they have a direct connection to each other. A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

“Optionally” means discretionary; not required; possible, but not compulsory; left to personal choice.

“Remote” generally refers to any physical, logical, or other separation between two things. The separation may be relatively large, such as thousands or millions of miles or kilometers, or small such as nanometers or millionths of an inch. Two things “remote” from one another may also be logically or physically coupled or connected together.

“Satellite Navigation” generally refers to a system that uses satellites to provide geo-spatial positioning data. In one example, the system may include a receiver that interacts with satellites using electromagnetic radiation. The timing of the transmission of the signal from the receiver to the satellites allows calculation of the position of the receiver using triangulation. Some of examples of satellite navigation systems include global positioning systems such as GPS and GLONASS as well as global positioning systems under development such as Galileo. A satellite navigation system may also be a regional positioning system such as BeiDou, NAVIC, and QZSS.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Short-range communication” generally refers to any network that is capable of transmitting data over short distances using high-frequency electromagnetic radiation. Some of examples of short-range communication protocols include, but are not limited to BLUETOOTH®, Wi-Fi, RFID, and ZigBee.

“Storage Container” generally refers to an object that can be used to hold or transport SKUs or other objects. By way of non-limiting examples, the storage container can include cartons, totes, pallets, bags, and/or boxes.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Tow Coupler” or “Trailer Coupler” generally refers to a device used to secure a trailer, a towed vehicle, and/or other towed object to a towing vehicle. Typically, but not always, the trailer coupler is coupled to a hitch of the towing vehicle. For example, the trailer coupler can be configured to couple to a hitch ball. Common types of trailer couplers include (but are not limited to) straight tongue couplers, A-frame couplers, adjustable couplers, and fifth wheel-gooseneck couplers. The trailer coupler can include any number of mounting styles. By way of non-limiting examples, the mounting styles can include straight channel, foldaway, round tongue, A-frame, flat mount, adjustable tongue, lunette ring, gooseneck, trigger, thumb, wrap around yoke, and pin mounting styles or mechanisms. The trailer coupler in some instances can further include a trailer jack for lifting the trailer coupler to the proper height for coupling to the hitch.

“Tow Hitch”, “Trailer Hitch”, or “Hitch” generally refers to a device attached to a chassis of a vehicle for towing another object, such as a trailer, aircraft, wagon, and/or another vehicle, to name just a few examples. Tow hitches are commonly mounted with bolts or other fasteners to the chassis, but in other examples, the tow hitch can be integrally formed with the chassis and/or attached in other ways such as via welding. Typically, but not always, the trailer hitch is coupled to a trailer coupler that is secured to the towed object. There are a number of types of tow hitches. For example, the tow hitch can include receiver type and fixed drawbar type hitches. Receiver type hitches can include a receiver mounted to the chassis and a removable mount that is connected to the receiver. In one form, the receiver is in the form of a receiver tube that defines a receiver opening in which the removable mount is mounted, such as via a bolt or other fastener, and/or otherwise connected. The removable mount can for example include one or more ball mounts, hitch bike racks, cargo carriers, and/or other hitch mounted accessories. Fixed drawbar type hitches are typically, but not always, built as a unitary piece that is mounted to the chassis. The fixed drawbar type hitch normally includes one or more holes for a trailer ball or other mounts. The trailer mounts can for instance take the form of a tow ball to allow swiveling and articulation of a trailer; a knuckle coupling; a tow pin or a tow hook with a trailer loop coupling; and/or a pintle and lunette ring coupling. The tow hitches can for instance include Society of Automotive Engineers (SAE) class I, II, III, IV, and V hitches.

“Trailer” generally refers to an unpowered vehicle towed by another vehicle. For instance, a trailer can include a nonautomotive vehicle designed to be hauled by road, such as a vehicle configured to transport cargo, to serve as a temporary (or permanent) dwelling, and/or acting as a temporary place of business. Some non-limiting examples of trailers include open carts, semi-trailers, boat trailers, and mobile homes, to name a just few. Typically, trailers lack a power train for propelling themselves over long distances and require another powered vehicle to move them. However, trailers may include a power source, such as a battery or generator, for powering auxiliary equipment.

“Truck” means a powered truck (also known as a tractor or cab) for pulling one or more trailer(s).

“Vehicle” generally refers to a machine that transports people and/or cargo. Common vehicle types can include land based vehicles, amphibious vehicles, watercraft, aircraft, and space craft. By way of non-limiting examples, land based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Wall” means here is structure that forms a solid surface. It may be a portion of a house, room, or otherwise. A wall may be planar or multiplanar and may be constructed of any of a variety of materials, including, but not limited to metal, concrete, wood, or plastic.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up.” “down,” “top.” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 harvesting system
102 combine
105 trailer
110 vehicle
112 mule
115 trailer wheels
120 mule wheels
125 auger
405 body
410 tarp
415 hopper
420 landing gear
505 channel
510 sidewalls
515 coupling deck conveyor
605 wheel mounting holes
610 wheel deck
615 wheel deck conveyor
620 witness holes
625 coupling deck
905 trailer guides
1200 grain bagger
1205 chute
1210 grain bag
1305 harvesting system
1310 field
1315 truck
1320 depot
1325 mule
1330 storage device
1335 parking spaces
1400 flowchart
1405 stage
1410 stage
1415 stage
1420 stage
1500 flowchart
1505 stage
1510 stage
1515 stage
1520 stage
1525 stage
1530 stage
1535 stage
1600 flowchart
1605 stage
1610 stage
1615 stage
1620 stage
1625 stage
1630 stage
1705 stage
1710 stage
1715 stage
1720 stage
1725 stage
1730 stage
1800 flowchart
1805 stage
1810 stage
1815 stage
1820 stage
1825 stage
1900 flowchart
1905 stage
1910 stage
1915 stage
1920 stage
1925 stage
1930 stage
1935 stage
2005 stage
2010 stage
2015 stage
2020 stage
2025 stage
2030 stage
2035 stage
2105 stage
2110 stage
2115 stage
2120 stage
2125 stage
2130 stage
2135 stage
2205 stage
2210 stage
2215 stage
2220 stage
2225 stage
2230 stage
2235 stage
2240 stage
2245 stage
2250 stage

What is claimed is:

1. A commodity transfer system, comprising:
a trailer;
a vehicle; and
a crop receiving facility.

2. The commodity transfer system of claim 1, wherein the trailer includes a moisture sensor configured to detect a moisture content of one or more crops.

3. The commodity transfer system of claim 1, wherein the trailer has landing gear and a motor configured to automatically extend and retract the landing gear upon detection of the vehicle.

4. The commodity transfer system of claim 3, wherein the landing gear includes one or more large-footprint pads configured to prevent trailer sinking.

5. The commodity transfer system of claim 1, wherein the trailer includes one or more retractable wheels.

6. The commodity transfer system of claim 5, wherein the wheels are configured to retract after the trailer is hooked to the vehicle to reduce compaction.

7. The commodity transfer system of claim 1, wherein the trailer includes an automatic tarp system configured to open and close based on commands from the vehicle.

8. The commodity transfer system of claim 7, wherein the trailer includes one or more sensors configured to detect tarp position.

9. The commodity transfer system of claim 1, wherein the trailer includes a rotating rear door for crop removal.

10. The commodity transfer system of claim 9, wherein the trailer includes one or more door sensors configured to detect rear door position.

11. The commodity transfer system of claim 10, wherein the trailer includes a dump hoist for crop removal.

12. The commodity transfer system of claim 11, wherein the trailer includes an on-board controller configured to monitor the door sensors and tarp sensors to detect load tampering.

13. The commodity transfer system of claim 1, wherein:
the trailer includes a Real-time Kinematic Positioning Global Positioning System (RTK GPS); and
the RTK GPS is configured to use the trailer as a base station for sending real-time corrections to the vehicle.

14. The commodity transfer system of claim 1, wherein the trailer includes one or more electrically controlled grain hoppers configured to open and close based on commands from the vehicle.

15. The commodity transfer system of claim 1, wherein the vehicle is at least a level 4 autonomous vehicle configured to autonomously move the trailer to and from a combine.

16. The commodity transfer system of claim 1, wherein the vehicle is configured to fully support the weight of the trailer to prevent trailer ground contact.

17. The commodity transfer system of claim 16, wherein the vehicle includes a flat-bed type trailer support system configured to slide beneath the trailer during an autonomous trailer hooking and dropping process.

18. The commodity transfer system of claim 17, wherein the vehicle and trailer include one or more sensors, channels, and/or rollers configured to facilitate autonomous hooking and dropping of the trailer.

19. The commodity transfer system of claim 1, wherein the vehicle includes a load sensor configured to detect a loading pattern of the crops in the trailer.

20. The commodity transfer system of claim 1, wherein the vehicle includes a conveyor system configured to receive grain from one or more hoppers and transport grain throughout the vehicle.

21. The commodity transfer system of claim 20, wherein the vehicle includes an auger configured to automatically transport grain from the conveyor system into a grain bagger.

22. The commodity transfer system of claim 21, wherein the vehicle and trailer communicate via telemetry to control automatic hooking and dropping and automatic fill of the grain bagger.

23. The commodity transfer system of claim 1, further comprising a real-time marketplace for crop transfer based on an estimated crop load weight, moisture content, and location information.

24. The commodity transfer system of claim 23, wherein the marketplace includes a remote device having a real-time job board for crop hauling to customer.

25. The commodity transfer system of claim 24, wherein the real-time job board displays available crop load pickup and drop off locations.
